(19) United States
(12) Patent Application Publication
(10) Pub. No.: US 2007/0277596 A1
(43) Pub. Date: Dec. 6, 2007

(54) Automatic Chlorophyll Analyzer And Analytical Method

(75) Inventors: Eun-Hee Kim, Ansan city, Kyeonggi-do (KR); Sung-Hyun Kahng, Ansan city, Kyeonggi-do (KR); Bum-Ju Khang, Incheon city (KR); Sung-Sun Park, Ansan city, Kyeonggi-do (KR); Song-Bum Choi, Ansan city, Kyeonggi-do (KR); Jae-Gu Ahn, Seoul (KR); Chang-Yong Oh, Seoul (KR)

Correspondence Address: RODMAN RODMAN, 10 STEWART PLACE, SUITE 2CE, WHITE PLAINS, NY, 10603, US

(73) Assignee: CENTENNIAL TECHNOLOGY COMPANY, Ansan-si, Gyeonggi-do (KR)

(21) Appl. No.: 11/577,049

(22) PCT Filed: Oct. 13, 2005
(86) PCT No.: PCT/KR05/03411

§ 371 Date: Apr. 12, 2007

(30) Foreign Application Priority Data
Oct. 13, 2004 (KR) 10-2004-0081942
Oct. 11, 2005 (KR) 10-2005-0095459

(51) Int. Cl. G01N 21/64

(52) U.S. Cl. 73/61.48

(57) ABSTRACT

An automatic chlorophyll analyzer and an analytical method for measuring fluorescence of chlorophyll after automatic processes of sample filtration and pigment extraction is disclosed, wherein the analyzer comprises: a flow path for fluid transfer; a multi-port valve for selectively connecting one of its ports with the said flow path; a filter for separating particulate materials from water sample and chlorophyll extract; a detector for measuring the fluorescence of chlorophyll extract; a syringe pump for picking up or dispensing the water sample; and a 4-port valve connected to the said syringe for selecting and switching flow paths.

### TECHNICAL FIELD

The present invention relates to automatic chlorophyll analyzer which measures chlorophyll concentration in water sample. More particularly, the invention relates to an automatic chlorophyll analyzer and analytical method which measures the fluorescence of chlorophyll after the automatic processes of sample filtration and pigment extraction.

### BACKGROUND ART

Chlorophyll is a key biochemical component essential for photosynthesis in terrestrial and marine environments. In general, the amount of chlorophyll in a collected water sample is used as an indicator of phytoplankton biomass, the magnitude of which can significantly affect the overall quality of the water.

Monitoring chlorophyll concentration is largely used for diagnosing water quality and productivity of phytoplankton. Today, with the advent of remote sensing, it has become possible to predict fishery production and global climate changes using monitoring ocean color from the space.

A classical method of determining the quantity of chlorophyll at a particular site is to collect a fairly large amount of water sample and to analyze it in a laboratory. The procedure involves filtration of the sample to concentrate the chlorophyll containing organisms, mechanical rupturing of the collected cells, and extraction of the chlorophyll from the disrupted cells into the organic solvent, acetone. The extract is then analyzed by a spectrophotometric method using the known optical properties of chlorophyll. Thereafter fluorometric determination of chlorophyll was introduced and it was fifty times more sensitive than that of the previous method. At present, with the development of analytical instrument, fluorescence assays for extracted chlorophyll are two to three orders of magnitude more sensitive than spectrophotometric method. For this reason, fluorometric chlorophyll techniques have been popular these days.

Measuring chlorophyll in vivo, i.e. without disrupting the cells as in the extractive analysis, was also proposed as an alternative method. Various in vivo chlorophyll sensors have been developed for continuous monitoring of chlorophyll.

### DISCLOSURE OF INVENTION

### Technical Problem

However, the results of in vivo analysis are not as accurate as those of the certified extractive analysis procedure, because fluorescent readings are significantly influenced by photo-inhibition, water temperature, turbidity, dissolved fluorescence materials, plankton cell structure, particle size, and organism type. The chlorophyll determination using in vivo fluorescence is probably the most convenient, but least accurate method in determining chlorophyll.

It has been impossible to automate the standard protocol for fluorometric determination of chlorophyll concentration, because the pretreatment procedures such as concentrating phytoplankton onto a filter, homogenizing glass fiber filter, extracting pigments, and removing particulate materials in extract with centrifugation are too complicated to be automated.

Filtration process in chlorophyll analysis is necessary for separating phytoplankton cells from water sample and concentrating them onto a filter. Vacuum pump or pressure pump is employed in filtering water sample and a glass fiber filter such as Whatman GF/F is usually used to strain phytoplankton from water sample. It is hard to automate the filtration process since glass fiber filter is not proper for repeated uses. In order to insert a new filter into filter holder, complicated robotic arms or a series of filter sets may be needed, but they make the system bulky and also confine the number of samples to be analyzed. Roll-type filters for continuous filtration cannot be used for this kind of application either, because it is impossible to extract chlorophyll from specific part of the roll type filter.

Filtration volume depends on the particulate load of water. Generally, five liters of water sample may be required in the open ocean, especially in the low productive areas, whereas less than one liter of sample is sufficient enough for lakes or coastal waters. When chlorophyll concentration in the water sample is high, the filtration volume should be reduced to prevent filter clogging. When the concentration is low, the filtration volume should be increased to guarantee analytical precision and accuracy according to the detection limit of the detector. In general, the filtration volume is determined in the field on the basis of water color and filtration speed. However, this adaptive process is hard to be applied in automatic analytical procedure. To automate this process, it is necessary to detect the in vivo fluorescence in advance to get the rough information of the chlorophyll concentration in the water sample, and then adjust the filtering volume.

A glass fiber filter is soaked into organic solvent such as acetone for extraction. Homogenization or sonification can be applied to enhance the extraction efficiency with rupturing phytoplankton cells and extracting pigments from the particulate materials filtered on the filter. Following the extraction of chlorophyll, centrifugation process is needed to remove particulate materials from pigment extract solution before spectrophotometric and fluorometric measurement. Homogenization and centrifugation are important preparation steps but hard to be automated.

### Technical Solution

A principal object of the present invention is to solve the aforementioned difficulties in measuring chlorophyll in freshwater and seawater. The present invention provides innovative automated processes of sample filtration, pigment extraction, particulate removal, fluorescence measurement, and filter clean-up with a minimum size of instrumentation. So the present invention of automatic chlorophyll analyzer is suitable even for unmanned analysis in such fields as laboratory, buoy, monitoring station, research vessel.

In accordance with one object of the present invention, there is provided an automatic chlorophyll analyzer comprising: a flow path for fluid transfer; a multi-port valve for connecting selectively one of its ports with the said flow path; a filter for separating particulate materials from water sample and chlorophyll extract; a detector for measuring the fluorescence of chlorophyll extract; a syringe pump for picking up or dispensing water sample; and a 4-port valve connected to the syringe for selecting and switching flow paths.

The analyzer may further comprise an ultrasonic transducer for generating ultrasonic waves onto the filter, and a cartridge for holding the filter as well as for guiding the water sample to flow only through the filter. Preferably the said cartridge comprises: two separable parts, i.e., a front panel and a rear panel; and the filter between the two parts. More preferably, the ultrasound transducer is attached to the rear panel of the cartridge to produce ultrasound onto the filter.

The automatic chlorophyll analyzer may further comprise an organic solvent bag communicating with an inlet port and outlet port linked to the multi-port valve; wherein the extract is extracted from the particulate materials with organic solvent.

Preferably, the filter is made of porous metal or plastic or ceramic with a pore size of 0.4˜0.5 micron. More preferably, the filter is an integral asymmetric filter made of a thin surface layer with 0.4˜0.5 micron pore size and 200 micron thickness, and a coarser support structure with 5˜50 micron pore size and 1000-2000 micron thickness.

The syringe pump may comprise a linear actuator for picking up and dispensing water sample. The syringe pump may further comprise a light emitter and a photoelectric sensor for detecting if the sample flows into or out of the syringe. Preferably, the light emitter and photoelectric sensor are attached to the syringe pump.

The automatic chlorophyll analyzer may further comprise a filtrate-storing bag which has an inlet and outlet port linked to the 4-way valve, wherein the filtrate is used for clean-up and backwash of the filter.

The analyzer may further comprise an HPLC (High Performance Liquid Chromatography) for quantifying individual pigment compounds after the fluorescence detection of chlorophyll. Preferably, the HPLC (High Performance Liquid Chromatography) comprise an injection valve connected to the said multi-port valve, an HPLC column for separating individual pigment compounds, and an HPLC detector for detecting chlorophyll.

### ADVANTAGEOUS EFFECTS

As apparent from the foregoing, this present invention provides innovative automated processes of sample filtration, pigment extraction, fluorescence measurement, and filter clean-up with minimum size of instrumentation, thereby enabling to be deployed for unmanned operation in fields such as laboratory, buoy, monitoring station, research vessel and the like.

### BRIEF DESCRIPTION OF THE DRAWINGS

FIG. 1 is a schematic diagram for the preferred embodiment of automatic chlorophyll analyzer

FIGS. 2 and 3 are sectional views for a filter cartridge with an ultrasonic transducer of the preferred embodiment of the automatic chlorophyll analyzer

FIGS. 4 and 5 are schematic diagrams for the syringe with a sensor for detecting filter clogging

FIG. 6 is a schematic diagram for the automatic chlorophyll analyzer with HPLC of another preferred embodiment

FIG. 7 is a perspective view for the automatic chlorophyll analyzer of another preferred embodiment

FIG. 8 is a typical chart showing the signals of fluorometric detector with increasing chlorophyll concentration

### BEST MODE FOR CARRYING OUT THE INVENTION

In accordance with another object of the present invention, there is provided with an automatic chlorophyll analyzing method comprising the steps of: prompting water sample to introduce into a flow path by way of a multi-port valve disposed at the flow path in which liquid flows and having a plurality of inlet and outlet ports and selectively communicating one of the inlet and outlet ports with the flow path; particulate materials contained in the water sample being separated by a filter disposed on the flow path; the separated particulate materials being extracted by organic solvent introduced by a multi-port valve and extracts having chlorophyll being filtered by the filter; and prompting the filtered chlorophyll extract to pass through a fluorescence detector disposed at the flow path to allow the fluorescence to be measured.

The method may further comprising the steps of: filtrate of water sample not containing the particulate materials is filtered by the filter and collected at a sample filtrate storage bag in the step of the particulate materials being separated by the filter; and the filter being cleaned by the filtrate not containing the particulate materials in the sample filtrate storage bag passing through the fluorescence detector and being reversely introduced into the filter in the fluorescence measuring step.

### MODE FOR THE INVENTION

Hereinafter, preferred embodiments of the present invention will be described in detail with reference to the accompanying drawings. The present invention is understood properly with the embodiments described hereunder, but it is not for confining the attached claims but just for exemplifying the best mode.

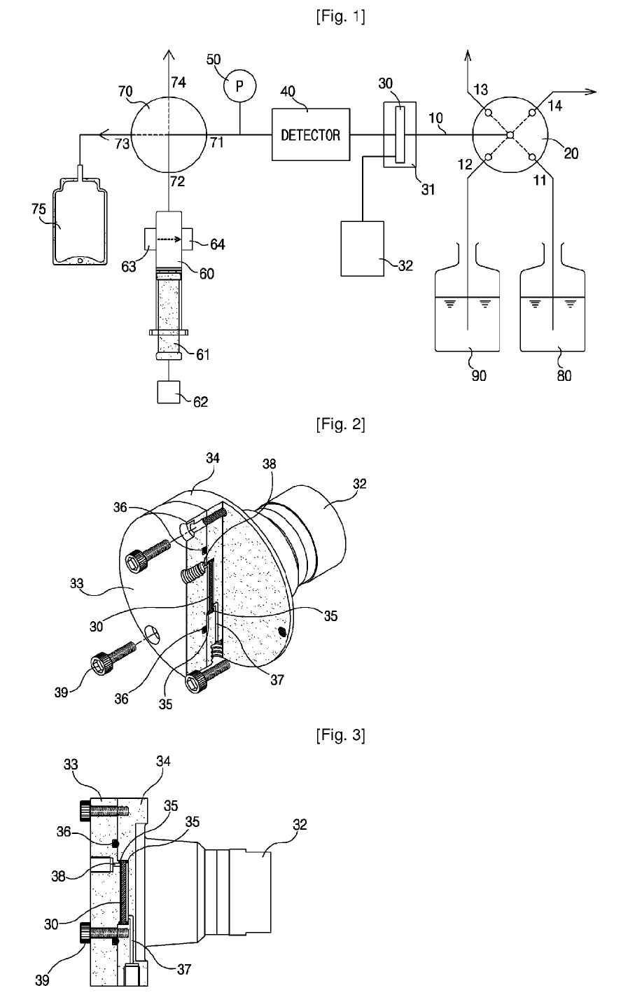

Referring to FIG. 1, the automatic chlorophyll analyzer of the present invention consists of a flow path 10 for fluid transfer, a multi-port valve 20 for selectively connecting one of its ports to the flow path 10, a filter 30 for separating particulate materials from water sample 80 and chlorophyll extract, a detector 40 for measuring the fluorescence of chlorophyll extract; a syringe pump 60 for picking up or dispensing water sample, a 4-port valve 70 connected to the said syringe for selecting and switching flow paths. Preferably, the multi-port valve 20, the filter 30, the detector 40 and the 4-port valve 70 are disposed on the flow path 10.

The automatic chlorophyll analyzer is operated as follows. First, the water sample 80 is introduced into the flow path 10 through the multi-port valve 20 which selectively connects one of its ports to the flow path.

After the inlet 11 of the multi-port valve 20 is connected to the water sample 80, the two ports 71, 72 of the 4-port valve are connected each other. Then a plunger 61 of the syringe pump 60 moves down to introduce the water sample 80 to the flow path by suction force. The introduced sample flows to the filter 30 installed in the flow path 10.

Particulate materials in the water sample 80 are strained onto the filter 30 and the filtrate goes through the filter 30. Namely, the particulate materials are separated by the filter 30 and only the filtrate without particulate materials passes through the filter 30 to reach the 4-port valve via the flow path 10. Finally it flows to the syringe 60.

The plunger 61 of the syringe 60 is operated by a linear actuator 62 attached to the syringe 60. The linear actuator 62 is for moving the plunger 61 up and down to pick up or dispense the water sample. Preferably, the linear actuator is attached to the syringe pump 60.

With the plunger 61 moving down, the water sample is introduced into the flow path 10 and particulate materials such as phytoplankton cells and suspended solids are separated by the filter 30 and only the filtrate without particulate materials is transferred to the syringe 60. When the plunger goes down to the bottom, the port 72 of the valve 70 is switched to the other port 73 and the plunger 61 goes up to dispense the filtrate within the syringe out of the flow path 10.

As mentioned above, the filtrate within the syringe can be transferred into a storage bag 75. The storage bag features a flexible container having a port connected to the port 73 of the 4-port valve 70 to store the filtrate. Namely, after the plunger 61 goes down to the bottom, the port 72 of the 4-port valve 70 is switched to the other port 73 connected to the storage bag. Then the plunger 61 goes up to dispense the filtrate in the syringe into the storage bag 75.

Filtration of the water sample 80 can be repeated with the same procedures described above and its filtration volume can be adjusted by the number of repetition.

Surplus volume of filtrate exceeding the capacity of the storage bag 75 can be disposed out of the flow path 10 by connecting the port 74 with the port 72 of the 4-port valve 70.

The filtration process begins with separating particulate materials which contains chlorophyll from the water sample with the filter 30, and this process can be effectively done with the specific filter proposed in the present invention.

The filter is desirably made of porous metal, plastic or ceramic with the pore size of 0.4˜0.5 micron. Preferably, materials of the filter are stainless steel, titanium, Teflon, PEEK, HDPE, and ceramic. It is desirable to use asymmetric filter to reduce the clogging of the filter, as well as to increase its permeability. The asymmetric filter is made of a thin surface layer with 0.4˜0.5 micron pore size and 200 micron thickness, and a coarser support structure with 5˜50 micron pore size and 1000-2000 micron thickness. Asymmetric membranes enhance the speed of sample filtration as well as the efficiency of filter backwash and cleaning.

The surface area of the filter limits the retention capacity of straining the particulate materials from the water sample. It is necessary to adjust filtration volume of the water sample 80 based on the amount of particulate materials in order to prevent the clogging of the filter 30, and to provide appropriate analytical sensitivity of the detector 40.

When chlorophyll concentration is low, filtration volume should be automatically increased to guarantee analytical precision and accuracy according to the detection limit of detector. In case chlorophyll concentration is high and the clogging of the filter occurs, filtration volume should be reduced intelligently. There are several ways to adjust filtration volume according to the particulate load as well as to prevent the clogging of the filter. The ways include, for example, (a) pre-assessment of biomass by measuring in vivo fluorescence and turbidity, (b) measuring pressure difference across the filter, (c) monitoring the load of linear actuator motor 62 installed at the syringe pump 60, and (d) mounting a photoelectric sensor to the syringe for liquid detection.

First, a) in vivo chlorophyll fluorometer and turbidity meter can be added to the analyzer in order to assess in advance the concentration of biomass and suspended solid to automatic chlorophyll analysis.

Secondly, b) vacuum gauze 50 measuring pressure difference across the filter can be installed to detect the clogging of metal filter. When the plunger 61 goes down, monitoring the change of pressure across the filter provides the information on the beginning of filter clogging. While the plunger moves down, the pressure inside the syringe decreases when the filter clogs. The signal of pressure drop is useful for intelligently deciding the point of terminating filtration process.

Thirdly, c) monitoring the load of the motor 62 installed at the syringe pump can detect the clogging of filter. When vacuum inside the syringe 60 increases with clogging, the torque of syringe drive motor 62 increases steeply. It is possible to intelligently stop the filtration before complete clogging of the filter by monitoring the change of torque.

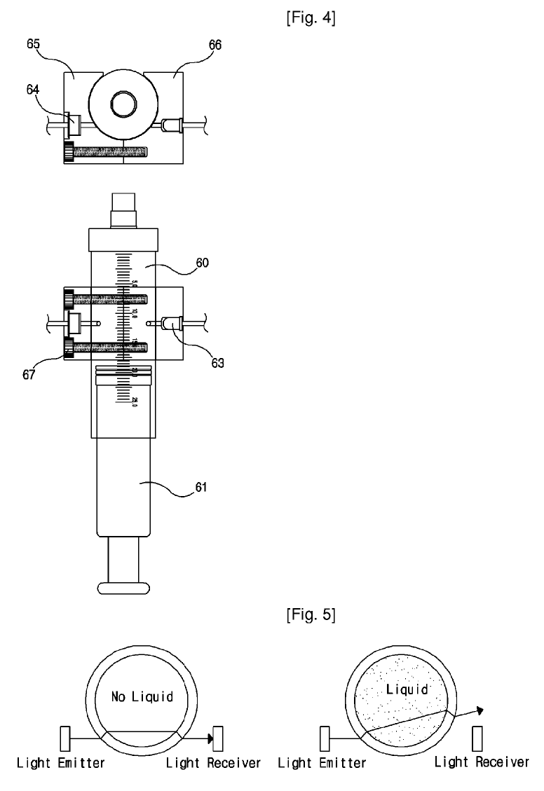

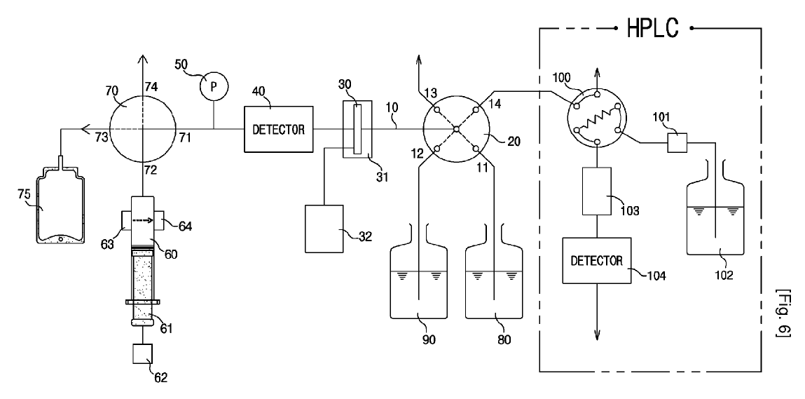

Lastly, d) specially designed photoelectric sensor mounted on the syringe can also provide direct signal of the presence of liquid inside the syringe. FIGS. 4 and 5 are schematic diagrams for the syringe with a sensor for detecting filter clogging. As shown in FIG. 4, it is desirable to include a light emitter 63 and a photoelectric sensor 64 to detect the presence of liquid inside the syringe 60. The light emitter 63 and the photoelectric sensor 64 are desirably attached to the syringe pump 60.

As shown in FIG. 4, two semi-circular attachments 65, 66 are mounted on the syringe to detect the presence or absence of liquid to check the clogging of filter. One of semi-circular attachment has an infra-red light emitter 63, while the other has a photo-detector 64. The semi-circular attachments 65, 66 are attached to the exterior of the syringe pump with screws 67.

The photoelectric sensor can provide information of a beginning of filter clogging by means of the mounting of an infra-red light emitter 63 and a photo-detector 64. An infrared light beam 63 is refracted and undetectable by the photo-detector 64 when the liquid is present, while the light beam 63 is not refracted and can be detectable by the photo-detector 64 when the liquid is absent. As the plunger 61 moves down, the filtrate flows into the syringe 60. When the filter starts to clog, the amount of the filtrate volume flowing into the syringe significantly decreases. The signal change patterns of the photoelectric sensor 63 can provide the information on the beginning and degree of filter clogging.

As described above, during the filtration step, the particulate materials are strained from water sample onto the filter 30, then chlorophyll is extracted from the particulate materials with organic solvent. After filtration is done, the filtrate inside the syringe is dispensed to the storage bag. The multi-port valve 20 is then switched to connect the flow path 10 to the port 12 linked to the bottle containing organic solvent 90. The organic solvent 90 is picked up into the flow path 10 by moving the plunger 61 down. Chlorophyll pigment contained in the particulate materials is extracted with organic solvent. For this process, the present invention utilizes ultrasonic transducer which generates ultrasound onto the filter 30. The ultrasound destroys the phytoplankton cells of the particulate materials and expedites extraction process.

The analyzer according to the present invention may comprise a cartridge 31 that holds the filter 30 and guides the water sample to flow only therethrough. It is preferred, as shown in FIG. 2, that the cartridge is comprised of two separable parts, that is, a front panel 33 and a rear panel 34, and the filter 30 between the two parts.

FIGS. 2 and 3 depict the filter cartridge 31 with the filter 31. The filter cartridge is comprised of two separable parts, the front panel 33 and the rear panel 34, which include the filter 30, filter O-rings 35, and a cartridge O-ring 36. The two O-rings 35 inserted on the both sides of the filter prevent the leak of water sample through a gap between the filter and filter cartridge. A large O-ring 36 installed at the cartridge checks air introduction into the flow path through the filter cartridge. The O-rings should be chemically inert against the organic solvent such as Teflon O-rings or Teflon encapsulated rubber O-rings.

An ultrasound transducer 32 is preferably attached to the rear panel 34 of the cartridge 31 to produce ultrasound onto the said filter. As shown in FIG. 3, inside the filter cartridge, water flows from the inlet 37 at the bottom to the outlet 38 at the top to prevent the retention of air bubble. The front panel 33 and the rear panel 34 are jointed together with screws 39 after the filter and O-rings are installed thereinside.

The present invention is designed to extract chlorophyll pigment with organic solvent from the particulate materials strained on the filter contained within the filter cartridge. The organic solvent 90 is picked up into the flow path 10 by moving the plunger 61 down. The plunger 61 moves down until the organic solvent just fills the filter cartridge, and stops. The ultrasonic transducer 32 generates ultrasound onto the filter 30 to destroy cells and promote extraction.

When solvent extraction is done, the plunger 61 moves down again to separate the particulate materials and cell fragments from the chlorophyll extract. This procedure can replace the centrifugation step of conventional chlorophyll analysis protocol to remove particulate materials from the extract. The extract passes through the filter, and then the filtered extract flows through the flow cell of fluorescence detector 40 which is in the flow path 10.

During the process above, it is desirable to slow down the speed of the plunger in order to promote the mixing of the extract inside the filter cartridge. Ultrasound also promotes the mixing process within the filter cartridge during fluorescence detection.

When the extract flows through the flow cell of the detector 40, the excitation light of 430 nm induces fluorescence. The fluorescence of chlorophyll is measured at 680 nm. Peak area or peak height is converted to the reading of chlorophyll concentration. After the measurement of fluorescence, the port 74 of the valve 70 is opened, and the extract is vented by moving up the plunger 61.

Analyzer according to the another embodiment of the present invention may comprise devices for HPLC analysis to quantify individual pigment compounds. FIG. 6 shows a schematic diagram of the preferable embodiment of the present invention including HPLC.

As shown herein, preferably, the HPLC may comprise: an injection valve 100 connected to the said multi-port valve; an HPLC column 103 for separating individual pigment compounds; and an HPLC detector 104 for detecting chlorophyll. The HPLC is connected to the multi-port valve 20 through the injection valve 100, and may contain an HPLC pump 101 for transporting solvent.

After the measurement of fluorescence was done by the detector 40, the port 12 of the multi-port valve 20 is connected to the port 14, and the pigment extract is carried to the loop of the injection valve 100 by moving up the plunger 61. The extract is loaded in the loop of the valve 100 and then injected to the HPLC column 103 by HPLC pump 101. Then the extracted pigments are separated into individual compounds, and measured with the HPLC detector 104.

The embodiment shown in FIG. 6 features the automation of sample pre-treatment for HPLC analysis. FIG. 6 shows a schematic diagram of an automatic analyzer that enables sample pre-treatment, separation and quantification of phytoplankton pigment compounds. The automatic chlorophyll analyzer described in this invention can be used as a sample pre-treatment unit for HPLC analysis of individual pigment compounds.

The present invention includes a backwash step to clean-up the filter and the loop after the fluorescence of the extract is measured by the detector. Namely, the automatic chlorophyll analyzing method according to the present invention may further comprising the steps of: filtrate of water sample 80 not containing the particulate materials is filtered by the filter 30 and collected at a sample filtrate storage bag 75 in the step of the particulate materials being separated by the filter 30; and the filter 30 being cleaned by the filtrate not containing the particulate materials in the sample filtrate storage bag 75 passing through the fluorescence detector 40 and being reversely infused into the filter 30 in the fluorescence measuring step.

When the extract is discarded, the filter 30 is back-washed with the filtrate stored in the storage bag 75. Namely, the port 73 of the valve 70 is connected to the port 72 of the syringe pump 70 again, and the plunger 61 goes down to pick up the filtrate into the syringe 60 from the storage bag 75. After the port 71 of the valve 70 is opened again, the port 13 of the multi-port valve 20 is linked to the vent port 13. The plunger 61 moves up to dispense the filtrate toward the filter cartridge 31 and to wash out the flow path 10 and the filter 30. At this time, the ultrasound can enhance the backwash of the filter to remove particle debris on the filter. Backwash and clearing of the filter can be repeated several times with the same procedures described above.

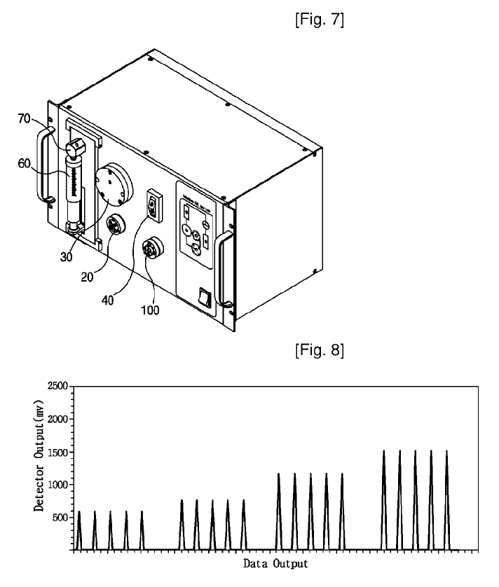

FIG. 7 illustrates a perspective view of an automatic chlorophyll analyzer according to the invention. As shown herein, the multi-port valve 20, the filter 30, the fluorescence detector 40, the syringe pump 60, the 4 port-valve 70, and the HPLC injection valve 100 are installed at the front panel.

FIG. 8 is a typical chart showing signals of fluorescence detector generated by the preferred embodiment of the automatic chlorophyll analyzer. As shown, peak height of output signal increases according to the increase of the chlorophyll concentrations.

Chlorophyll concentration is calculated with peak area or height. Calibration curve for the quantification of chlorophyll concentration can be prepared by chlorophyll standards.

### INDUSTRIAL APPLICABILITY

The present invention described above is comprised of a multi-port valve, a filter, a filter cartridge, a ultrasonic transducer, a fluorescence detector, a vacuum gauge, a syringe pump for picking up or dispensing water sample, and a valve attached to the syringe pump, and provides the automatic chlorophyll analyzer which automatically detects chlorophyll concentration by measuring the fluorescence of pigment extract through concentrating the phytoplankton cells onto a reusable filter followed by extraction with organic solvent.

1. An automatic chlorophyll analyzer comprising:
a flow path for fluid transfer;
a multi-port valve for selectively connecting one of its ports with the said flow path;
a filter for separating particulate materials from water sample and chlorophyll extract;
a detector for measuring the fluorescence of chlorophyll extract;
a syringe pump for picking up or dispensing the water sample;
and a 4-port valve connected to the said syringe for selecting and switching flow paths.

2. The analyzer as defined in claim 1 further comprising an ultrasonic transducer for generating ultrasonic waves onto the said filter.

3. The analyzer as defined in claim 1 further comprising a cartridge for holding the filter and for guiding the water sample to flow only through the filter.

4. The analyzer as defined in claim 3, wherein the cartridge comprises:
two separable parts, a front panel and a rear panel; and
the filter between two parts.

5. The analyzer as defined in claim 4, wherein an ultrasound transducer is attached to the rear panel of the cartridge to produce ultrasound onto the said filter.

6. The analyzer as defined in claim 1 further comprising an organic solvent bag having an inlet port and outlet port linked to the multi-port valve, wherein the extract is extracted from the particulate materials with the organic solvent.

7. The analyzer as defined in claim 1, wherein the filter is of porous metal or plastic or ceramic with a pore size of 0.4˜0.5 micron.

8. The analyzer as defined in claim 1, wherein the filter is an integral asymmetric filter made of a thin surface layer with 0.4˜0.5 micron pore size and 200 micron thickness, and a coarser support structure with 5˜50 micron pore size and 1000-2000 micron thickness.

9. The analyzer as defined in claim 1, wherein the syringe pump comprises a linear actuator for picking up and dispensing water sample.

10. The analyzer as defined in claim 1 further comprising a light emitter and a photoelectric sensor for discriminating if the sample flows into or out of the syringe.

11. The analyzer as defined in 10, wherein the light emitter and photoelectric sensor are attached to the syringe pump.

12. The analyzer as defined in claim 1 further comprising a bag for storing filtrate which has an inlet and outlet port linked to the 4-way valve, wherein the filtrate is used for clean-up and backwash of the filter.

13. The analyzer as defined in claim 1 further comprising an HPLC (High Performance Liquid Chromatography) capable of quantifying individual pigment compounds after the fluorescence detection of chlorophyll.

14. Analyzer as defined in claim 13, wherein the HPLC comprises:
an injection valve connected to the said multi-port valve;
an HPLC column for separating individual pigment compounds;
and an HPLC detector for detecting chlorophyll.

15. An automatic chlorophyll analyzing method comprising the steps of:
prompting water sample to introduce into a flow path by way of a multi-port valve disposed at the flow path in which liquid flows and having a plurality of inlet and outlet ports and selectively communicating one of the inlet and outlet ports with the flow path;
particulate materials contained in the water sample being separated by a filter disposed on the flow path;
the separated particulate materials being extracted by organic solvent introduced by a multi-port valve and extracts having chlorophyll being filtered by the filter; and
prompting the filtered chlorophyll extract to pass through a fluorescence detector disposed at the flow path to allow the fluorescence to be measured.

16. The method as defined in claim 15 further comprising the steps of:
filtrate of water sample not containing the particulate materials is filtered by the filter and collected at a sample filtrate storage bag in the step of the particulate materials being separated by the filter; and
the filter being cleaned by the filtrate not containing the particulate materials in the sample filtrate storage bag passing through the fluorescence detector and being reversely introduced into the filter in the fluorescence measuring step.
